(19) United States
(12) Patent Application Publication
(10) Pub. No.: US 2009/0042619 A1
(43) Pub. Date: Feb. 12, 2009

(54) Electronic Device with Morphing User Interface

(76) Inventors: Paul M. Pierce, Grayslake, IL (US); James E. Wicks, Lake Bluff, IL (US)

Correspondence Address: PHILIP H. BURRUS, IV, 460 Grant Street, Atlanta, GA, 30312, US

(21) Appl. No.: 11/836,973

(22) Filed: Aug. 10, 2007

(51) Int. Cl. H04B 1/38

(52) U.S. Cl. 455/566

(57) ABSTRACT

An electronic device (100) includes a high-resolution display (101) and a charged pigment display (103). The charged pigment display (103), which in one embodiment is an electrophoretic display, defines a user interaction region (106) and is configured, in conjunction with a controller (107), to present user actuation targets and information in the user interaction region. The information and user actuation targets may correspond to an operational mode of the device. The electronic device (100) may operate in control states, information states, and hybrid information/control states. Hyperlinks, brand information, and other data may be presented in the user interaction region (106).

### BACKGROUND

1. Technical Field

This invention relates generally to an electronic device having a changeable user interface, and more particularly to an electronic device having a charged pigment display configured as a morphing user input device.

2. Background Art

Portable electronic device manufacturers are designing increasingly more functionality into each device. While mobile telephones, for example, were once only able to make calls, many manufacturers now offer multi-function mobile devices with telephone capabilities, e-mail capabilities, photo and video capture capabilities, and gaming capabilities all integrated into a single device.

One problem associated with incorporating all of these features into a small hand-held device involves the keypad. More features generally mean more keys. More keys mean smaller keys, as the physical dimensions of portable electronic devices are limited. Smaller keys mean more difficult user operation. Some popular devices today come with more than 35 keys packed into a space of a few inches.

There is thus a need for an improved user interface.

### BRIEF DESCRIPTION OF THE DRAWINGS

FIG. 1 illustrates one embodiment of an electronic device having a charged pigment display user interface in accordance with the invention.

FIG. 2 illustrates one embodiment of a charged pigment display in accordance with the invention.

FIG. 3 illustrates an exploded view of one embodiment of user interface for an electronic device having a charged pigment display user interface in accordance with the invention.

FIGS. 4-10 illustrate various exemplary modes of operation for an electronic device having a charged pigment display user interface in accordance with embodiments of the invention.

FIGS. 11 and 12 illustrate embodiments of a predictive text entry mode of operation for an electronic device having a charged pigment display user interface in accordance with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention are that of an electronic device having a dynamic user interface configured to change user actuation targets and information with the active mode of the device. A charged pigment display, such as an electrophoretic display, is used as a user input device. By altering the orientation of the charged pigments, various device information or user actuation targets may be presented in a user interaction region of the user interface. In one embodiment, only those controls necessary for controlling the present mode of information are present in the user interaction region. In another embodiment, user actuation targets may be augmented with textual and graphical information associated with the current mode of operation of the device.

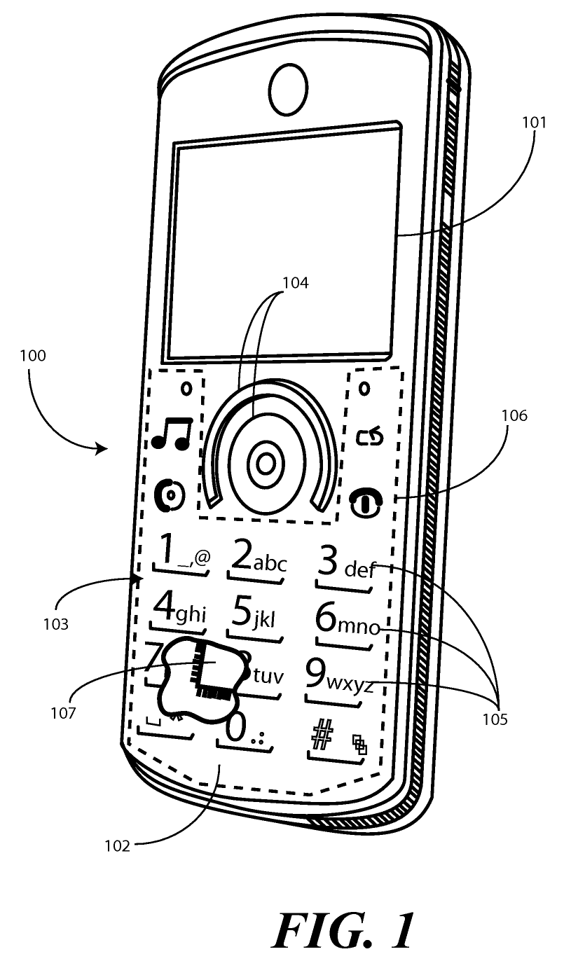

Turning now to FIG. 1, illustrated therein is one embodiment of an electronic device 100 having a user interface 102 in accordance with the invention. The user interface 102 includes three major sections: a high-resolution display, 101 a charged pigment display 103 defining a user interface region 106, and a navigation device 104. The charged pigment display 103 is disposed proximately with the high-resolution display 101 along the user interface 102. The navigation device 104, continually accessible to a user in one embodiment, is disposed between the high-resolution display 101 and the charged pigment display 103. The navigation device 104 is used, among other things, for navigating among different operational modes of the electronic device 100.

The high-resolution display 101, which in one embodiment is a liquid crystal display (LCD), is configured to present device information to the user. The term “high-resolution display” is used herein to refer to a device that can present text and images to a user by altering a large number of pixels which, when viewed collectively by a user, form the presented text or image. The high-resolution display 101 is used for the presentation of text, information, and graphics on a mobile device with sufficient granularity as to be easily switched between graphics or text. For example, the high-resolution display 101 would be one suitable for presenting an image in the Joint Photographics Expert Group (JPG) format to the user. Such displays generally are configured to turn on and off individual pixels by way of a display driver for the presentation of high-resolution information. Examples include a 256 pixel by 128 pixel reflective or backlit LCD. Exemplary high-resolution display devices are manufactured by Samsung and Sony.

The user interaction region 106 is an area within the user interface 102 with which the user enters data and information. The charged pigment display 103 defines at least a portion of the user interaction region 106 and is coupled to a controller 107 disposed within the electronic device 100. The controller 107, by way of embedded software, is configured to selectively present user interface information. The user interface information corresponds to the operational mode of the device. In the exemplary embodiment of FIG. 1, the operational mode is that of a mobile telephone. As such, the user interface information of FIG. 1 comprises a plurality of user actuation targets arranged as a twelve-digit key pad and associated controls.

The controller 107 presents the user interface information by arranging and rearranging charged color pigments. When the mode of the electronic device 100 changes, the controller 107 is configured to rearrange the colored pigments so as to present user interface information associated with the new mode. For example, when the electronic device 100 changes from a mobile telephone mode to a photo capture mode, the user interface information morphs from the twelve-digit keypad to a photo capture control set.

The charged pigment display 103, which may be an electrophoretic or electronic-ink device, has resolution capabilities sufficient for the presentation of medium-resolution graphics or text. As such, in addition to controls and user actuation targets, the user interface information may also include visible information—either in the form of text or graphics—associated with information being presented on the high-resolution display 101. By way of example, if the electronic device 100 is in a music player mode, a picture of the artist may be presented on the high-resolution display 101, while brief biographic information is presented on the charged pigment display 103 in the user interaction region 106. Further, as will be discussed in further detail below, a hyperlink to connect to merchandising sites or sites having additional information about the artist may be presented. Some embodiments of the invention allow the user to define specific types of information to be displayed in the user interaction region 106, as well as the style and format in which that information is displayed. Such information is changeable and constantly under the control of the user.

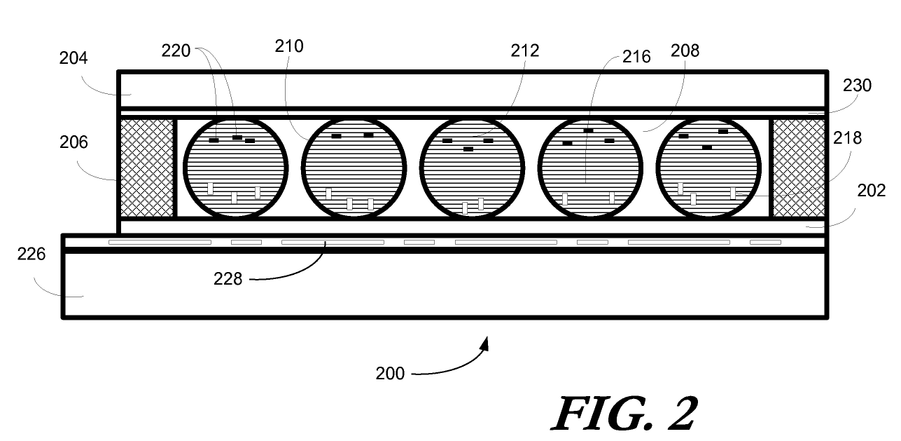

Turning now to FIG. 2, illustrated therein is one exemplary embodiment of a charged pigment display in accordance with the invention. As noted above, in one embodiment, the user interface information is presented in the user interaction region by way of an electrophoretic display. FIG. 2 illustrates one such display. It will be clear to those of ordinary skill in the art having the benefit of this disclosure that the invention is not so limited. Other devices, including those operating by moving particles electrophoretically in gels, powders, gasses, or other transfer media, may also be used.

Electrophoretic displays are manufactured by suspending particles in a medium, examples of which include gas, liquid, or gel, between two substrates. The particles may optionally be encapsulated in small capsules that are held between the walls, or they may be emulsified in a polymeric matrix. The particles have optical properties that are different from the medium in which they are suspended. Due to the electrochemical properties of the particles, and of the medium, the particles spontaneously acquire a net charge when placed in the medium. Having a charge, the particles will move in the presence of an externally applied electric field. Transparent electrodes, generally manufactured by depositing indium-tin oxide (In.sub.2 O.sub.3—SnO.sub.2), often in the shape of pixels, apply selective electric fields to the particles, thereby causing the particles to rotate and move to the viewable display surface. This movement causes an image to appear at the viewable display surface. Electrophoretic displays tend to be both very efficient in terms of electrical current consumption. Further they are generally available at a reasonable cost.

In FIG. 2 is illustrated a sectional view of an electrophoretic display 200. This electrophoretic display 200 includes a lamination adhesive 202 coupling a thin film transistor backplane 226 and a transparent front substrate 204. An adhesive 206 is generally employed to bond and seal the perimeters of the lamination adhesive 202 and the front substrate 204, thereby forming a chamber 208.

A plurality of capsules 210,212 is disposed within in the chamber 208. Each of the capsules 210,212 encloses a medium 216, such as hydrocarbon oil in liquid-based electrophoretic materials, with light and dark particles 218,220 suspended therein. Some of these particles 218, which may be made from titanium dioxide, are generally white (i.e. reflective across the visible spectrum). Other particles 220 may be pigmented with a dark colored dye so as to appear black. (Other color schemes, resulting from slightly different chemistries, may also be used.) With surfactants and charging agents, the white particles 218 are positively charged while the black particles 220 are negatively charged.

The front substrate 204 is a transparent substrate that is tied electrically to ground or a common node by a layer of transparent electrode material 230, such as indium-tin oxide. When an electric field is applied to electrodes 228 disposed along the back substrate by the controller 107, the particles 218,220 migrate electrophoretically so as to form an image viewable to the user. For example, when the white particles 218 move to the top of the capsule 210 they become visible as the color white to the user from the front side. At the same time, the electric field pulls the black particles 220 to the bottom of the capsules 210 where they are hidden. By reversing this process, the black particles 220 appear at the top of the capsule 210, which becomes visible as the color black. In such a manner, the controller 107 is configured to selectively present the user interface information be rearranging the charged pigment particles 218,220 with an applied electric field.

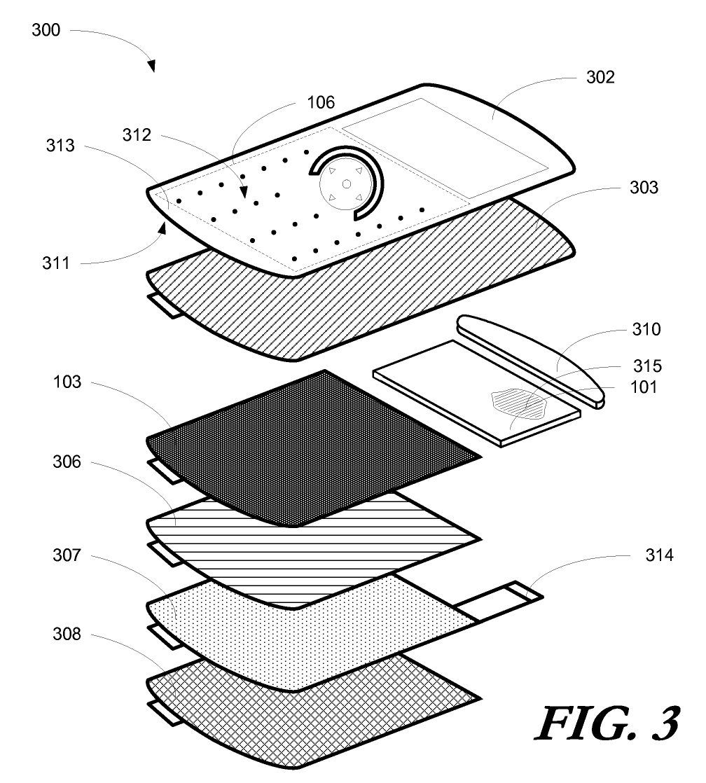

Turning now to FIG. 3, illustrated therein is an exploded view of a dynamic user interface 300 for a portable electronic device (100) in accordance with one embodiment of the invention. The user interface 300 includes a user interaction region 106 defined by the charged pigment display 103. The user interface 300, in one embodiment, is made from several layers, each layer implementing a different function. While several layers are shown, it will be clear to those of ordinary skill in the art having the benefit of this disclosure that each and every layer may not be required for a specific application. By way of example, the proximity sensor, shown in FIG. 3 as a capacitive sensor 303, may not be needed for all devices.

The exemplary user interface 300 of FIG. 3 includes the following components: a cover layer 302; a capacitive sensor 303; a charged pigment display 103, an optional resistive switch layer 306; a substrate layer 307; and an optional tactile feedback layer 308. Additionally, the high-resolution display 101 and filler materials 310 may be included to complete the assembly. While the layers are shown individually, it will be clear to those of ordinary skill in the art having the benefit of this disclosure that some of the various layers may be combined together. For instance, the cover layer 302 and capacitive sensor 303 may be integrated together to form a single layer. Similarly, the tactile feedback layer 308 may be integrated into the cover layer 302, and so forth.

Starting from the top with the cover layer 302, a thin film sheet serves as a unitary fascia member for the electronic device (100). A “fascia” is a covering or housing, which may or may not be detachable, for an electronic device like a mobile telephone. While the drawings herein employ a mobile telephone as an exemplary electronic device for discussion, it will be clear to those of ordinary skill in the art having the benefit of this disclosure that the invention is not so limited. The fascia of the present invention could be used for any electronic device having a display and a keypad, including gaming devices, personal digital assistants, pagers, radios, and portable computers.

The cover layer 302, in one exemplary embodiment, is a thin, flexible membrane. Suitable materials for manufacturing the thin, flexible membrane include clear or translucent plastic film, such as 0.4 millimeter, clear polycarbonate film. In another embodiment, the cover layer 302 is manufactured from a thin sheet of reinforced glass. The glass may be reinforced by a strengthening process, such as a chemical or heat treatment process. The cover layer, being continuous and without holes or other apertures or perforations, is well suited to serve as a fascia for the electronic device (100), as it prevents dust, debris and liquids from invading the device.

To provide ornamentation, text, graphics, and other visual indicators, the cover layer 302, in one embodiment, includes selective printing disposed on the rear face 311. The charged pigment display 103 is capable of providing graphics, and in some cases color, for the front surface of the electronic device (100). However, even in such an embodiment, selective printing on the cover layer 302 may be desirable. For instance, printing may be desired around the perimeter of the cover layer 302 to cover electrical traces connecting the various layers. Additionally, printing of select demarcations 312 may be desirable. In one embodiment, when the device is off, the font surface goes completely blank. Demarcations 312, which may be very light, small circles, provide the user with an indication of which portion of the front surface is the user interaction region 106.

Printing may be desired on the front face 313 for various reasons as well. For example, a subtle textural printing or overlay printing may be desirable to provide a translucent matte finish atop the electronic device (100). Such a finish is useful to prevent cosmetic blemishing from sharp objects or fingerprints. By printing only on the rear face 311, however, the front face 313 can remain smooth and glossy. When printing is done on the rear face 311 of the cover layer 302, the printing, being disposed on the inside of the device, is protected from wear and abrasion. There is generally no printing in either the user interaction region 106 or above the high-resolution display 101 so that each may be easily viewed.

The cover layer 302 may also include an ultra-violet barrier. Such a barrier is useful both in improving the visibility of the high-resolution display 101 and in protecting internal components of the electronic device (100).

The exemplary user interface 300 of FIG. 3 also includes a capacitive sensor 303. The capacitive sensor 303, which is constructed by depositing small capacitive plate electrodes on a substrate, is configured to detect the presence of an object, such as a user's finger, near to or touching the user interface 300. Control circuitry within the device detects a change in the capacitance of a particular plate combination on the capacitive sensor 303. The capacitive sensor 303 may be used in a general mode, for instance to detect the general proximate position of an object relative to either the user interaction region 106. The capacitive sensor 303 may also be used in a specific mode, where a particular capacitor plate pair may be detected to detect the location of an object along length and width of the front surface of the electronic device (100). In this mode, the capacitive sensor 303 may be used to detect the proximate position of an object, such as a user's finger, relative to any of the actuation targets presented.

Turning to the charged pigment display 103, in one embodiment this is an electrophoretic display and is configured to selectively present text, graphics, user actuation targets, and controls in the user interaction region 106. Since information present on an electrophoretic display remains without the continual application of energy, the charged pigment display 103, in one embodiment, may continue to present user interface information even when the high resolution display 101 is OFF, inactive, or in a low-power mode.

The configuration of user actuation targets and other information may be mode-based. This means that the keypad configuration or information presented in the user interaction region 106 corresponds to a particular mode of operation of the electronic device (100). For example, a camera mode may correspond to a camera keypad configuration and photo capture information, while a phone mode may correspond to a telephone keypad user actuation target configuration and associated controls.

The high resolution display 101, which may have its own back-lighting system and may also include a polarizing layer 315, may be placed adjacent to the charged pigment display 103. Further, filler material 310 may be included to complete the assembly.

The resistive switch layer 306 serves as a force switch array configured to detect contact with the surface of the user interface 300. An “array” as used herein refers to a set of at least one switch. For instance, where the cover layer 302 is manufactured from glass, one switch may be all that is necessary. However, when the cover layer 302 is manufactured from thin film plastic, multiple switches may be employed. The array of resistive switches functions as a force-sensing layer, in that when contact is made with the user interface, changes in impedance of any of the switches may be detected. The array of switches may be any of resistance sensing switches, membrane switches, force-sensing switches such as piezoelectric switches, or other equivalent types of technology.

A substrate layer 307 is provided to carry the various control circuits and drivers for the layers of the display. The substrate layer 307, which may be either a rigid layer such as FR4 printed wiring board or a flexible layer such as copper traces printed on a flexible material such as Kapton®, can include electrical components, integrated circuits, processors, and associated circuitry to control the operation of the display. The substrate layer 307 includes a connector 314 for coupling to the controller (107) or to other electrical components within the electronic device (100).

In one embodiment of the user interface 300, for example where the cover layer 302 is manufactured from glass, a modicum of cover layer deflection is all that is required to actuate one of the keys presented by the charged pigment display 103. This deflection can be on the order of tens of micrometers. As such, a user may not physically perceive any deflection at all when pressing each key.

To provide tactile feedback, an optional tactile feedback layer 308 may be included. The tactile feedback layer 308 may include a transducer configured to provide a sensory feedback when a switch on the resistive switch layer detects actuation of a key. In one embodiment, the transducer is a piezoelectric transducer configured to apply a mechanical “pop” to the user interface 300 that is strong enough to be detected by the user. Thus, the tactile feedback layer provides sensory feedback to the user, thereby making the smooth, substantially planar user interface 300 react like a conventional keypad without the need of individual popple-enabled keys protruding through the keypad.

Note that the layers may be coupled together in any of a variety of ways. One exemplary embodiment of a coupling mechanism is by using a thin layer of clear (transparent), non-conductive adhesive. For instance, the cover layer 302, the capacitive sensor 303, and the segmented optical shutter 304 may each be mechanically coupled together with non-conductive, translucent adhesive. This coupling keeps the overall assembly properly aligned within the device.

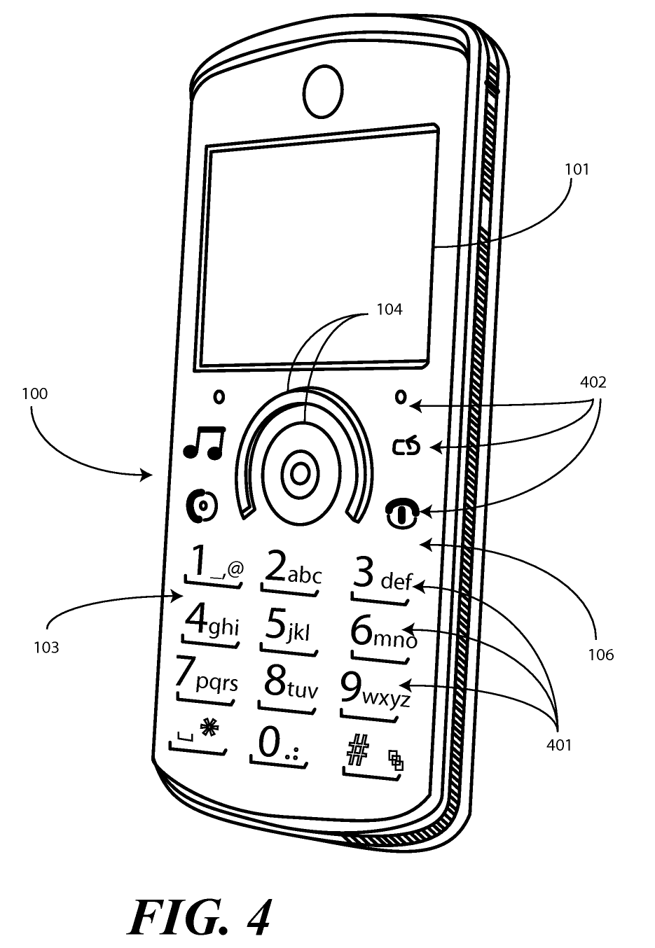

Turning now to FIGS. 4-10, illustrated therein are some exemplary modes of operation for an electronic device 100 having a charged pigment display 103 defining a user interaction region 106 in accordance with embodiments of the invention. While many different modes are shown, it will be clear to those of ordinary skill in the art that the invention is not so limited. With the flexibility of the charged pigment display, other modes of operation may be employed with little or no changes to the hardware. Simple software enhancements for the controller (107) are all that is required to design new modes of operation.

Turning first to FIG. 4, illustrated therein is the electronic device 100 in a phone mode. When the electronic device 100 is OFF, inactive, or in a low-power mode, the charged pigment display 103 may be configured to be blank. The electronic device 100 may transition into an operational mode, such as a radiotelephone or phone mode shown in FIG. 4, by a user touching the user interface (300) as sensed by the capacitive sensor (303). When this occurs, the electronic device 100 transitions to a control state, as user actuation targets are present in the user interaction region. As will be shown below, the electronic device 100 may transition from control states to informational states, and vice versa, and to and from hybrid control/informational states.

In the phone mode, the charged pigment display 103 is configured to present a plurality of user actuation targets 401 within the user interaction region 106. In the phone mode of FIG. 4, the user actuation targets 401 are configured as a twelve-digit telephone keypad. The navigation device 104 is present for navigating to other modes as desired. Additional controls and short-cut actuation targets 402 are also presented in the user interaction region 106. Information relating to the telephone mode, such as the call recipient or the number being dialed, may be presented on the high-resolution display.

Note that while the navigation device 104 may be used for navigation between the operational modes of the electronic device 100, this is not the only way for the electronic device to transition from one mode to another. The electronic device 100 may additionally transition modes due to an input from a remote source. For example, where the electronic device 100 is in a low-power mode, the electronic device may transition to the phone mode of FIG. 4 when an incoming call is received. Similarly, the electronic device 100 may transition to a messaging mode when an incoming text message or incoming multimedia message is received. Incoming data transmissions may cause the electronic device to enter other modes as well.

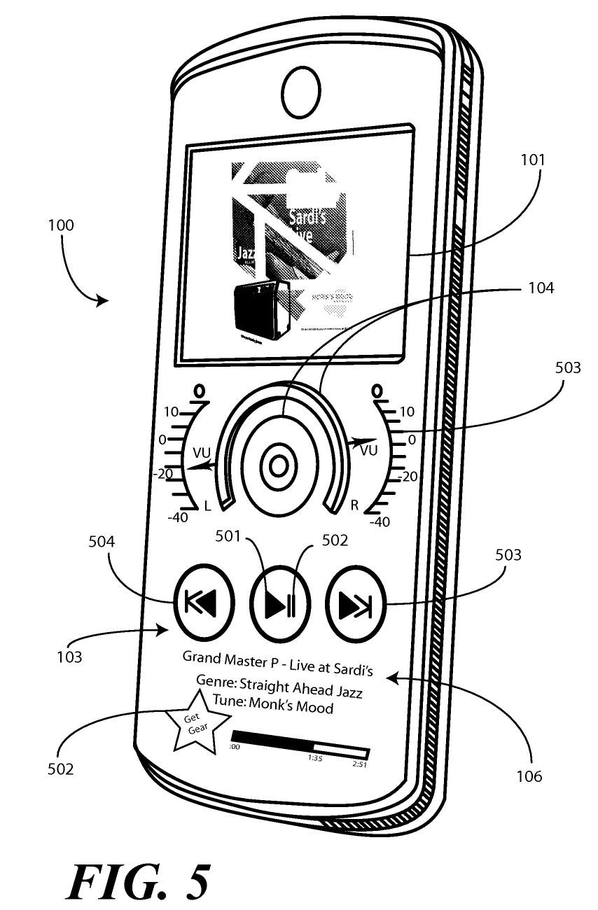

Turning now to FIG. 5, illustrated therein is the electronic device 100 in a music playback mode. In the music playback mode, the charged pigment display 103 includes at least a play button 501, a pause button 502, a rewind button 503, and a fast forward button 504. In FIG. 5, while user actuation targets are present in the user interaction region 106, the charged pigment display 103 has generally transitioned from a control state to a control/information state as information relating to the mode is presented within the user interaction region 106. In the exemplary embodiment of FIG. 5, the artist's name and song title are present in the user interaction region 106, while a picture of the album cover is present on the high-resolution display 101.

In addition to information, the charged pigment display 103, operating in concert with the proximity detector, can serve as a hyperlink 502. By touching the hyperlink 502, a user may be connected—through a network—to websites and other portals. The user may connect to these portals to obtain information relating to the purchase of goods or services related to the information presented on the high-resolution display 101. Such information, after the hyperlink 502 is actuated, may further be presented in the user interaction region 106. By way of example, while listening to a song, a user may touch the hyperlink 502 to obtain information relating to the purchase of concert apparel or other albums.

In another embodiment, the charged pigment display 103 may function as a state program. State programs are sometimes referred to as “widgets” in that they present some form of information and then retain that state until user input is received. For instance, one state program may be a “thought of the day” where a proverb or thought is presented when the state program is actuated. That state is retained until user input is received. Thus, the proverb or thought may remain on the charged pigment display 103 until the user elects to see another thought or proverb.

Additionally, either hyperlinks or state programs may be controlled across the network. Designers of the electronic device may elect to allow third party providers to control the hyperlinks or state programs such that they change in accordance with a remote program.

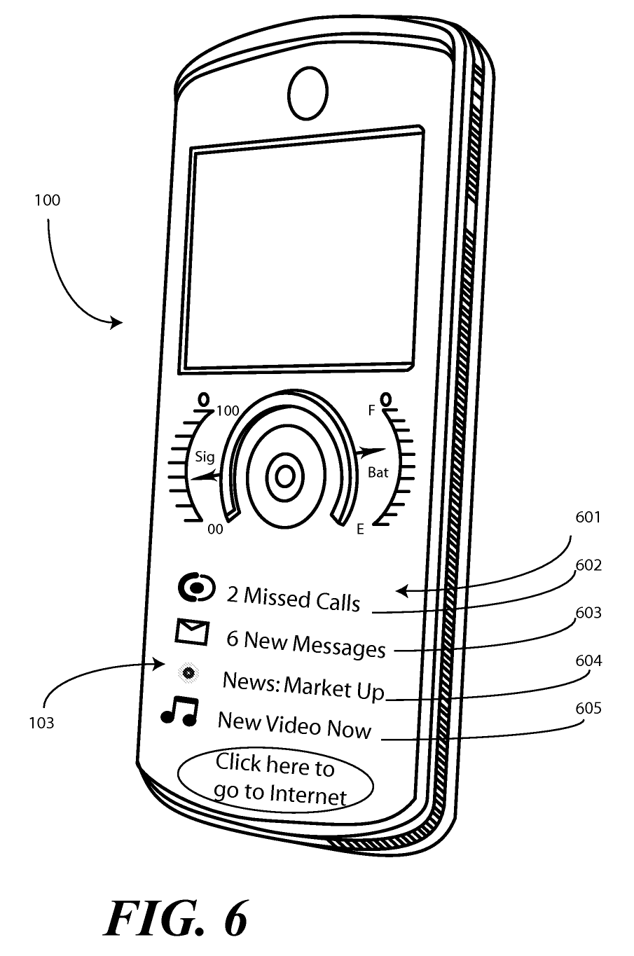

Some modes, such as the music player mode of FIG. 5, may permit the presentation of control settings by the charged pigment display 103 in the user interaction region. By way of example, in FIG. 5 audio setting control information 503 is presented about the navigation device 104. In this illustrative embodiment, the audio setting control information 503 includes left and right channel level information. It will be clear to those of ordinary skill in the art having the benefit of this disclosure, however, that the invention is not so limited. Other information, including volume information, time to play information, memory capacity information, battery level information (shown in FIG. 6), network information (such as data transfer rate), communication signal strength information (shown in FIG. 6), and the like, may be presented by the charged pigment display 103 in the user interaction region 106.

Further, thus user interface information, and its presentation style, in one embodiment, is user configurable. The user may select, for example, whether the information is presented as analog dials (as shown in FIG. 5), or as text. Additionally, the user may be able to select the font, size, and shape of the text. Some embodiments of the invention include template “skins” with various configurations of popular user information preferences included, to make configuration simpler.

Turning now to FIG. 6, illustrated therein is the electronic device 100 in a status mode. In the status mode, selective device information 601 is presented in the user interaction region 106. This device information 601 may include status information from the various modes of operation of the device. In the exemplary embodiment of FIG. 5 for instance, the device information includes phone mode information 602, portal information 603, message information 604, and video information 605. This information may be user configurable. For example, the user may select the three or four most used modes of operation for display in the status mode. Alternatively, the user may want the most recently updated information to be displayed. Further, each piece of device information 601 may be configured as an actuation target, in that touching the device information 601 may cause the electronic device 100 to enter that mode of operation.

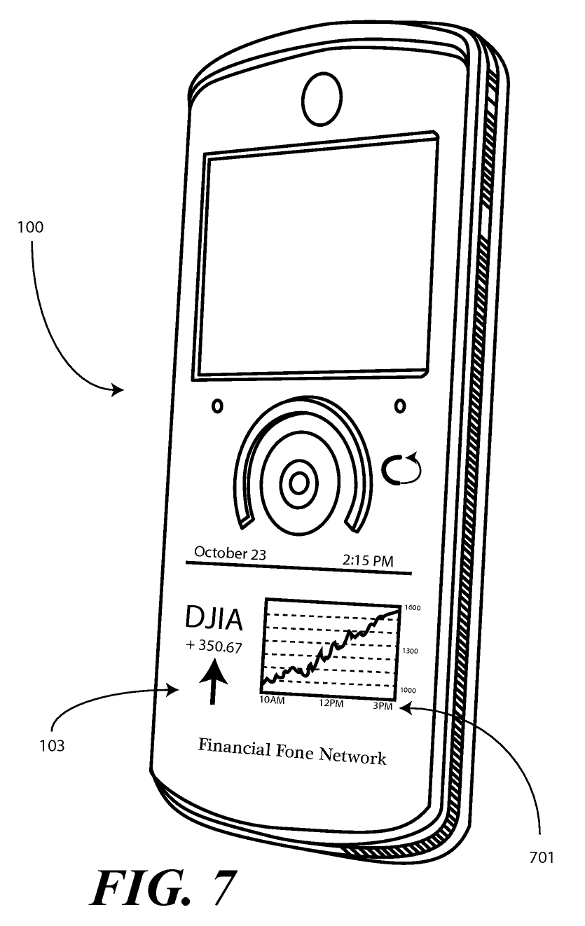

Turning now to FIG. 7, illustrated therein is the electronic device 100 in a financial information mode. In the financial information mode, data 701 such as stock and bond prices, futures prices, or company earnings reports may be presented by the charged pigment display 103. Such information may be obtained across a network, for instance, through an RSS feed. An RSS feed is a data feed that periodically transmits data. The charged pigment display 103 may be configured to continually update as RSS feed information is received. (RSS stands for data in one of the following formats: Really Simple Syndication (RSS 2.0); RDF Site Summary (RSS 1.0 and RSS 0.90); or Rich Site Summary (RSS 0.91).)

As the charged pigment display 103 may retain information presentation while in a low-power state, it may be advantageous to present information on the charged pigment display 103 rather than the high-resolution display 101 to save power. This is because the charged pigment display 103 generally uses power only to configure the charged pigments. The pigments stay in place until they are actively changed. As such, presenting information on the charged pigment display 103 is generally more efficient that presenting information on the high-resolution display 101, as the high-resolution display 101 requires continuous power while presenting data to a user.

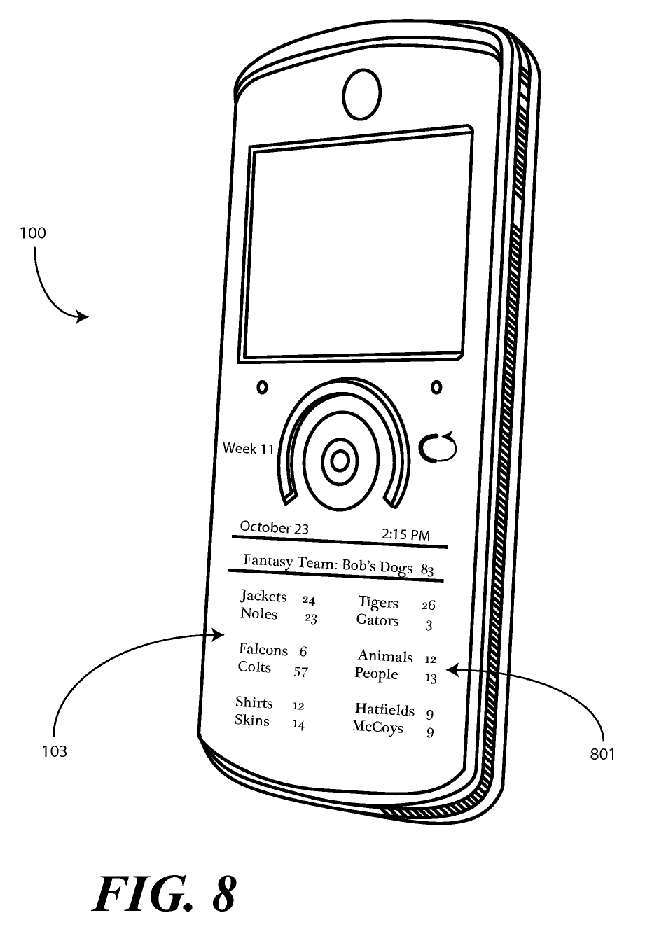

Turning now to FIG. 8, illustrated therein is the electronic device 100 in a gaming mode. Note that many gaming modes will include user actuation targets comprising game controls, such as directional controls and fire buttons. However, gaming modes can take many forms. In the exemplary embodiment of FIG. 8, the user has configured the charged pigment display 103 to present football scores from the previous week. The scores may be downloaded from a network, perhaps through a RSS feed.

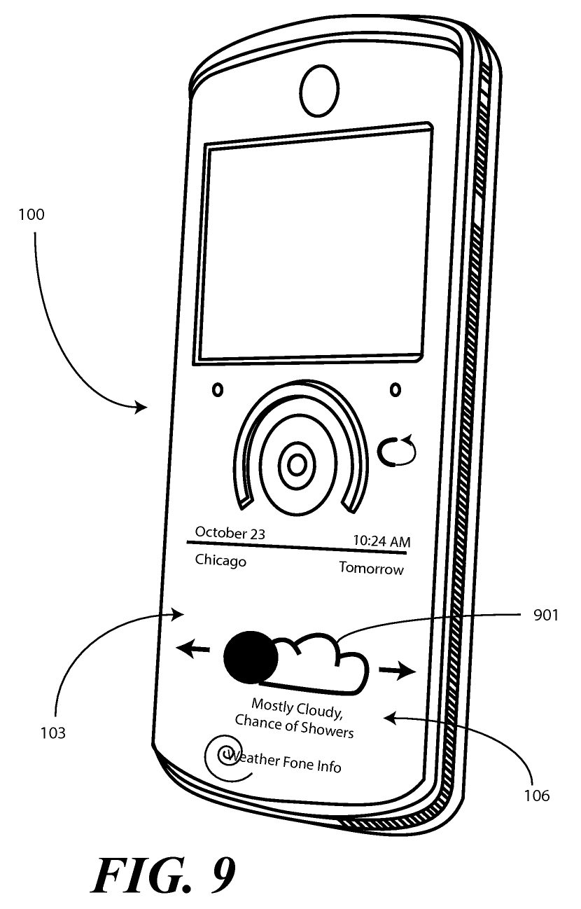

Turning now to FIG. 9, illustrated therein is the electronic device 100 in a weather mode. Weather information 901 is presented by the charged particle display 103 in the user interaction region 106. Like the other information presented in the informational states, the weather information 901 is user configurable. For instance, the user may configure the city or configuration of the information to be presented. Weather information 901 may be downloaded from a network, perhaps as a RSS feed.

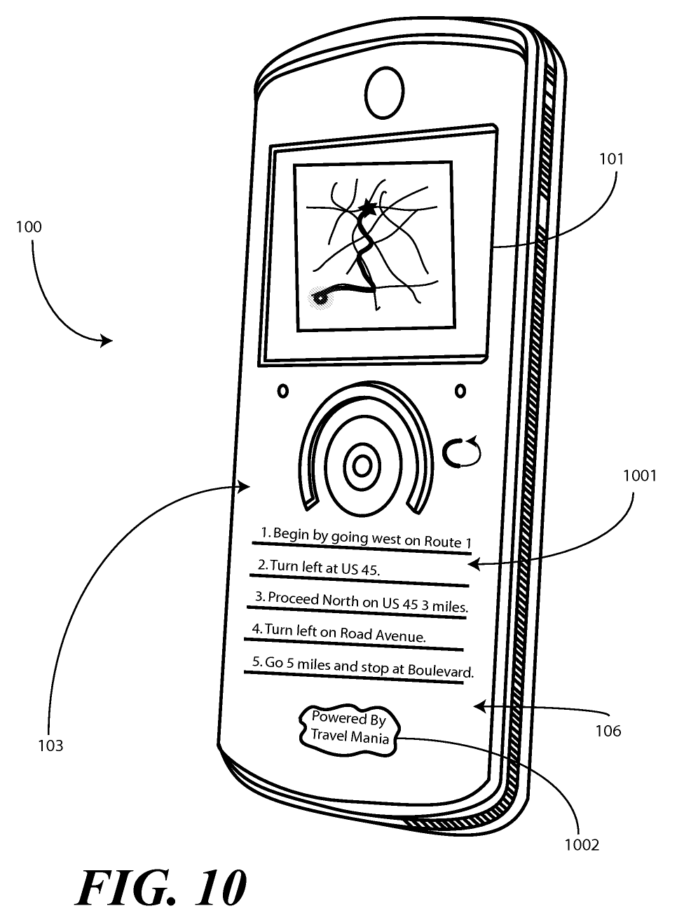

Turning now to FIG. 10, illustrated therein is the electronic device 100 in a navigational mode. In the navigational mode, direction information 1001 may be presented on the charged pigment display 103, while a map or other graphic is displayed on the high-resolution display 101. Additionally, where the information for the various modes comes from a particular vendor, a partner logo 1002 may be presented in the user interaction region 106. Such a partner logo 1002 may be used with any of the various operational modes. Navigation information may be downloaded from a network for presentation on the charged pigment display 103.

While a few of the operational modes have been illustrated in the previous figures, it will be clear to those of ordinary skill in the art having the benefit of this disclosure that the invention is not so limited. Other modes may be configured as well. By way of example, traditional multifunction device modes, including a media player mode, video player mode, picture display mode, text capture mode, picture capture mode, or video capture mode may be some of the modes suitable for use with an electronic device in accordance with embodiments of the invention. Further, interactive instructions relating to device operation may be displayed, with the information being split between the high-resolution display and the charged pigment display. By way of example, video content on how to use the device may be displayed on the high-resolution display while text that corresponds to the video would be displayed on the charged pigment display.

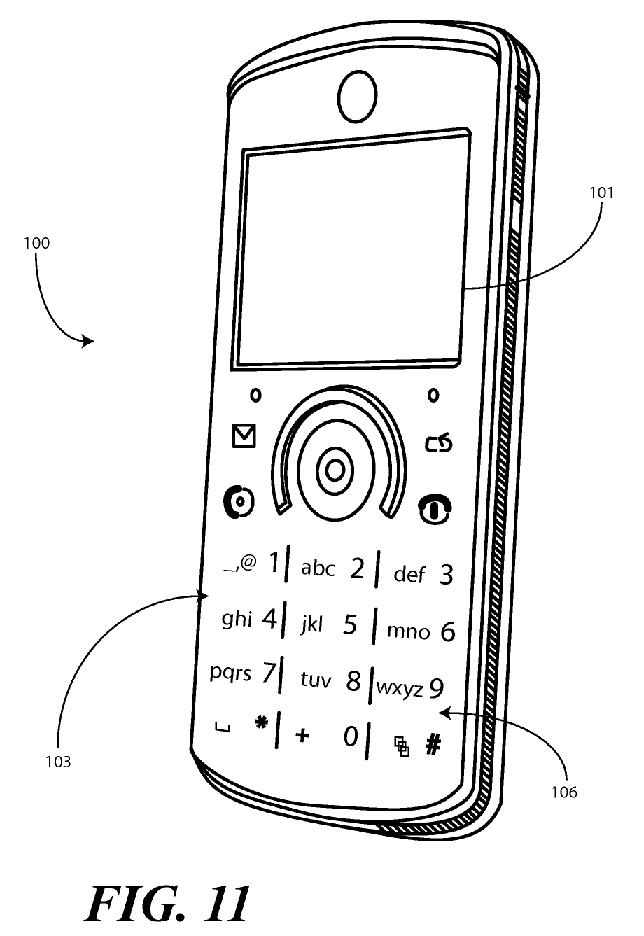

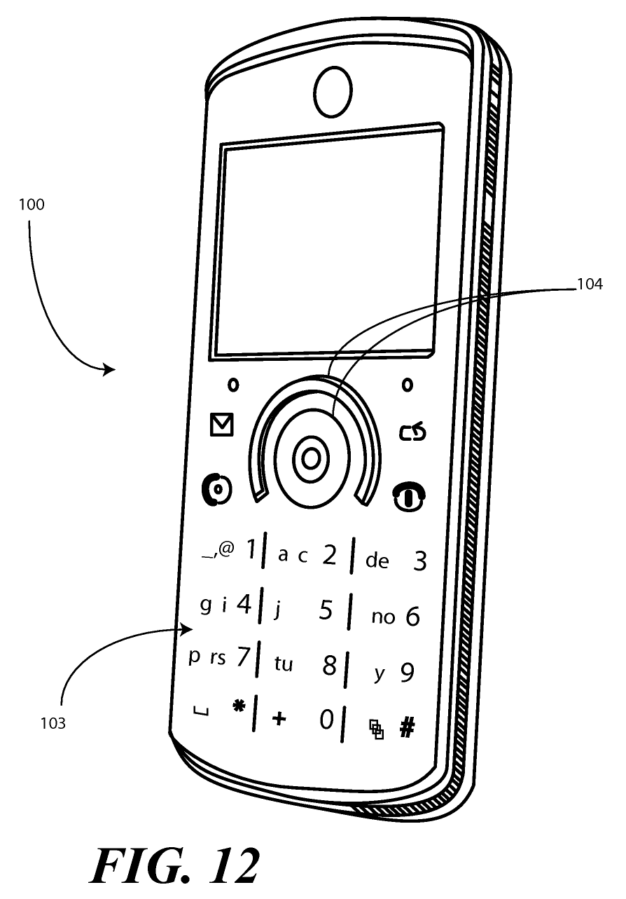

Turning collectively now to FIGS. 11 and 12, illustrated therein is the electronic device 100 in a messaging mode. In the messaging mode, the electronic device 100 is configured for text capture. Such a mode is suitable for creating e-mail messages, instant messages, text messages, or multimedia messages.

In one embodiment, the messaging mode includes a text capture state that offers a predictive text mode. Predictive text for electronic device messaging applications are known in the art. Such predictive text methods are discussed generally, for example, in U.S. Pat. Nos. U.S. Pat. No. 6,973,332 to Mirkin et al., issued Dec. 6, 2005, entitled “Apparatus and method for forming compound words,” U.S. Pat. No. 5,911,485 to Rossmann, issued Jun. 15, 1999, entitled “Predictive data entry method for a keypad,” U.S. Pat. No. 6,150,962 to Rossmann, issued Nov. 21, 2000, entitled “Predictive data entry method for a keyboard,” and U.S. Pat. No. 5,809,415 to Rossmann, issued Sep. 15, 1998, entitled “Method and architecture for an interactive two-way data communication network.” In traditional predictive text systems, a user enters a character or two, and a software algorithm anticipates possible words. The most likely match is presented on the high-resolution display.

Some embodiments of the present invention differ in that they employ the charged pigment display 103 to perform the predictive text function. Illustrating by way of example, in FIG. 11, the electronic device is seen in a state where a user is to begin typing a word. As the electronic device is in a text capture state, characters are presented in a pronounced fashion in the user interaction area. (Note that while the characters are presented in a traditional keypad arrangement, as the charged pigment display 103 is user configurable, the characters could have equally been presented in a QWERTY arrangement.)

Once a character has been entered, rather than presenting a possible matching word on the high resolution display, the charged pigment display 103 begins to remove characters from the user interaction region 106 as shown in FIG. 12. Where an unusual word is entered, the user may page through the various letter combinations by actuating the navigation device 104. By removing characters from the user interaction region 106, the user interaction region 106 becomes less cluttered and less cognitively loading, thereby simplifying operation. The charged pigment display 103 continually updates as the user enters additional information.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention.

What is claimed is:

1. An electronic device having a user interface, the user interface comprising:
a high-resolution display;
a charged pigment display disposed proximately with the high-resolution display, the charged pigment display defining a user interaction region; and
a controller coupled to the charged pigment display;
wherein the controller is configured to selectively present user interface information in the user interaction region, the user interface information corresponding to a operational mode of the electronic device.

2. The electronic device of claim 1, wherein the controller is configured to selectively present the user interface information by rearranging charged pigment particles with an applied electric field.

3. The electronic device of claim 1, wherein the charged pigment display comprises an electrophoretic display.

4. The electronic device of claim 1, wherein the user interface information comprises one of a plurality of mode-based keypad configurations.

5. The electronic device of claim 1, wherein at least one of the plurality of user actuation targets comprises a navigation device configured to permit navigation among operational modes of the electronic device.

6. The electronic device of claim 1, wherein a presentation style of the user interface information is user configurable.

7. The electronic device of claim 1, wherein the user interface information remains on the charged pigment display when the high-resolution display is inactive.

8. The electronic device of claim 1, further comprising a proximity sensor configured to detect a presence of an object within a predetermined distance of the user interaction region.

9. The electronic device of claim 8, further comprising a resistive force sensor configured to detect the object contacting the user interaction region.

10. The electronic device of claim 1, wherein the charged pigment display is configured to be blank when the electronic device is OFF.

11. The electronic device of claim 1, wherein the controller is further configured to selectively present device information to a user in the user interaction region of the electronic device, wherein the device information is one of battery capacity information, network information, or communication signal strength information.

12. The electronic device of claim 1, wherein the user interface information comprises a plurality of user actuation targets, wherein the plurality of user actuation targets comprises at least a play button, a pause button, a rewind button, and a fast forward button.

13. The electronic device of claim 1, wherein the user interface information comprises one of at least one hyperlink or at least one state program.

14. The electronic device of claim 1, wherein the operational mode of the electronic device is changed by an input from a remote source, wherein the input from the remote source is one of an incoming voice call, an incoming text message, an incoming multimedia message, or an incoming data transmission.

15. The electronic device of claim 1, wherein the controller is configured to transition from an informational state to a control state, thereby causing one or more user actuation targets to appear along the user interaction region.

16. The electronic device of claim 1, wherein the operational mode comprises one of a radiotelephone mode, a navigational mode, financial information mode, a gaming mode, a weather mode, a media player mode, a music player mode, a video player mode, a picture display mode, a text capture mode, a picture capture mode, or a video capture mode.

17. The electronic device of claim 16, wherein when the operational mode comprises the text capture mode and the controller is configured to operate in a predictive text mode.

18. The electronic device of claim 1, wherein the user interface information comprises information relating to a purchase of goods or services related to information presented on the high-resolution display.

19. The electronic device of claim 1, wherein when the operational mode comprises a music player mode, the user interface information comprises audio setting control information associated with the electronic device.

20. The electronic device of claim 1, wherein the operational mode comprises a device status mode.
